(19) United States
(12) Patent Application Publication
(10) Pub. No.: US 2025/0094456 A1
(43) Pub. Date: Mar. 20, 2025

(54) LARGE LANGUAGE MODEL OUTPUT ENTAILMENT

(71) Applicant: GOOGLE LLC, Mountain View, CA (US)

(72) Inventors: Kelvin Gu, Mountain View, CA (US); Zhuyun Dai, Mountain View, CA (US); Panupong Pasupat, Mountain View, CA (US); Chen Elkind, Mountain View, CA (US); Eran Ofek, Rehovot (CH); Hagai Taitelbaum, Mountain View, CA (US); Mukund Sundararajan, Mountain View, CA (US); Vered Cohen, Mountain View, CA (US); Itay Karo, Mountain View, CA (US); Norbert Kalb, Mountain View, CA (US); Yossi Matias, Tel Aviv (IL); Tej Toor, Brooklyn, NY (US); Teghan Tracy, Boulder, CO (US)

(21) Appl. No.: 18/887,751

(22) Filed: Sep. 17, 2024

Related U.S. Application Data
(60) Provisional application No. 63/539,033, filed on Sep. 18, 2023.

(51) Int. Cl. G06F 16/332; G06F 16/33; G06F 16/35

(52) U.S. Cl. CPC G06F 16/3329; G06F 16/3344; G06F 16/353

(57) ABSTRACT

Implementations are described herein for identifying potentially false information in generative model output by performing entailment evaluation of generative model output. In various implementations, data indicative of a query may be processed to generate generative model output. Textual fragments may be extracted from the generative model output, and a subset of the textual fragments may be classified as being suitable for textual entailment analysis. Textual entailment analysis may be performed on each textual fragment of the subset, including formulating a search query based on the textual fragment, retrieving document(s) responsive to the search query, and processing the textual fragment and the document(s) using entailment machine learning model(s) to generate prediction(s) of whether the at least one document corroborates or contradicts the textual fragment. When natural language (NL) responsive to the query is rendered at a client device, annotation(s) may be rendered to express the prediction(s).

### BACKGROUND

Generative models are types of machine learning models that generate sequences of output data based on sequences of input data. Large language models (LLMs) are one type of generative models that can perform various natural language processing (NLP) tasks, such as language generation, machine translation, and question-answering, to name a few. LLMs are typically trained on enormous amounts of diverse data including data from, but not limited to, webpages, electronic books, software code, electronic news articles, and machine translation data. Accordingly, these LLMs leverage the underlying data on which they were trained in performing these various NLP tasks. For instance, in performing a language generation task, these LLMs can process a natural language (NL) based input that is received from a client device, and generate a NL based output that is responsive to the NL based input and that is to be rendered at the client device.

One challenge of LLMs and generative models more generally is that they occasionally produce false information, sometimes referred to as “hallucinations.” False information erodes the trust of users and leads to decreased use of and reliance upon generative models. However, LLM-generated hallucinations are not always easily identifiable, and can be time consuming to validate manually.

### SUMMARY

Implementations are described herein for identifying, and presenting to users, potentially false information and/or hallucinations contained in documents and/or textual content, including but not limited to generative model output. More particularly, but not exclusively, techniques are described herein for performing entailment evaluation of documents and/or generative model output and providing user interface (UX) functionality that enables users to interact with various visual elements and/or annotations relating to the entailment evaluation.

In some implementations, a method may be implemented by one or more processors and may include: receiving a query associated with a client device operated by the user; generating generative model output based on processing, using a generative model, data indicative of the query; extracting a plurality of textual fragments from the generative model output; classifying a subset of the textual fragments as being suitable for textual entailment analysis; individually performing textual entailment analysis on each textual fragment of the subset, wherein the textual entailment analysis includes, for each textual fragment of the subset: formulating a search query based on the textual fragment, retrieving at least one document that is responsive to the search query, and processing the textual fragment and the at least one document using one or more entailment machine learning models to generate one or more predictions of whether the at least one document corroborates or contradicts the textual fragment; causing natural language (NL) responsive to the query to be rendered at the client device; and causing one or more annotations to be rendered at the client device, wherein the one or more annotations express one or more of the predictions for one or more of the textual fragments of the subset.

In various implementations, the one or more entailment machine learning models may include: a corroboration machine learning model trained to generate first output indicative of whether a document corroborates a textual fragment; and a contradiction machine learning model trained to generate second output indicative of whether a document contradicts a textual fragment. In various implementations, one or more of the predictions may be determined based on a comparison of the first and second outputs. In various implementations, one or more of the annotations may be rendered using one or more visual attributes that are selected based on the comparison

In various implementations, each textual fragment of the subset may be classified as suitable for textual entailment analysis using a classifier machine learning model that is trained to classify textual fragments as capable or incapable of textual entailment analysis. In various implementations, each textual fragment of the subset may be classified as suitable for textual entailment analysis based on an entailment score predicted for the textual fragment using a regression machine learning model that is trained to predict textual entailment analysis suitability scores for textual fragments.

In various implementations, the subset may include a plurality of textual fragments, and the textual entailment analysis is performed for the plurality of textual fragments in parallel. In various implementations, the one or more annotations expressing one or more of the predictions may include: a first annotation that visually highlights one of the textual fragments that is corroborated by one of the documents in a first color; and a second annotation that visually highlights another of the textual fragments that is contradicted by one of the documents in a second color that is different than the first color.

In various implementations, a given annotation of the annotations expressing one or more of the predictions may be operable to retrieve at least a portion of the document that corroborates or contradicts the textual fragment underlying the given annotation. In various implementations, the method may include causing a pop-up window to be rendered at the client device, wherein the pop-up window conveys the portion of the document that corroborates or contradicts the textual fragment underlying the given annotation. In various implementations, the method may include comprising causing a new web browser tab to be rendered at the client device, wherein the new web browser tab conveys all or a portion of the document that corroborates or contradicts the textual fragment underlying the given annotation. In various implementations, the new web browser tab may be automatically scrolled to a location of the document that contains the portion that corroborates or contradicts the textual fragment underlying the given annotation.

In various implementations, the method may include causing one or more interactive feedback elements to be rendered at the client device, wherein the one or more interactive feedback elements are operable to accept or reject one or more of the predictions for one or more of the textual fragments of the subset. In various implementations, the NL responsive to the query may be rendered at the client device without annotations prior to the one or more annotations being rendered. In various implementations, the one or more predictions of whether the at least one document corroborates or contradicts the textual fragment may be generated conditionally based on a responsive content quality metric determined for the at least one document.

In another related aspect, a method may be implemented using one or more processors, and may include: receiving a query associated with a client device operated by the user; generating generative model output based on processing, using a generative model, data indicative of the query; extracting a plurality of textual fragments from the generative model output; individually performing textual entailment analysis on each textual fragment, wherein the textual entailment analysis includes, for each textual fragment: formulating a search query based on the textual fragment, retrieving at least one document that is responsive to the search query, and processing the textual fragment and the at least one document using a corroboration machine learning model and a contradiction machine learning model to generate, respectively, a corroboration metric and a contradiction metric for the textual fragment; causing natural language (NL) responsive to the query to be rendered at the client device; and causing one or more annotations to be rendered at the client device, wherein the one or more annotations include one or more visual features that are selected based on a comparison of the corroboration and contradiction metrics. In various implementations, the one or more visual features may include a color used to highlight one or more of the textual fragments and/or a color used to render one or more of the textual fragments.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 schematically depicts an example of how various components described herein may cooperate to perform selected aspects of the present disclosure.

FIG. 3A and FIG. 3B schematically depict an example of a graphical user interface (GUI) being used in accordance with various implementations described herein.

FIG. 4 depicts an example of how corroboration and contradiction metrics can be compared to select annotation attributes, in accordance with various implementations.

FIG. 5 depicts a flowchart illustrating an example method of practicing selected aspects of the present disclosure.

FIG. 6 depicts an example architecture of a computing device, in accordance with various implementations.

### DETAILED DESCRIPTION

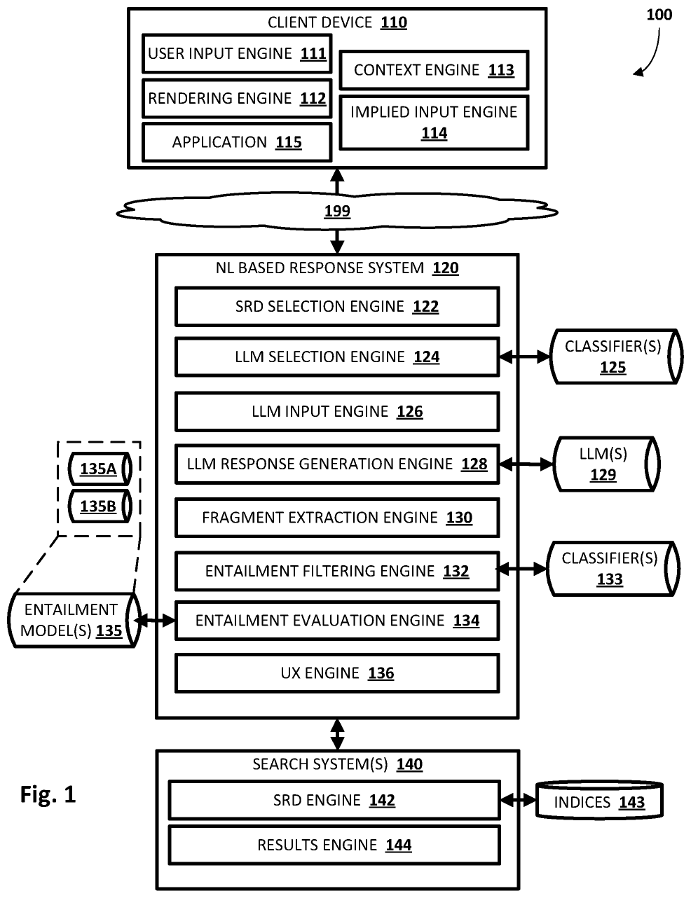

Turning now to FIG. 1, a block diagram of an example environment 100 that demonstrates various aspects of the present disclosure, and in which implementations disclosed herein can be implemented is depicted. The example environment 100 includes a client device 110, a natural language (NL) based response system 120, and search system(s) 140. Although illustrated separately, in some implementations all or aspects of NL based response system 120 and all or aspects of search system(s) 140 can be implemented as part of a cohesive system.

In some implementations, all or aspects of the NL based response system 120 can be implemented locally at the client device 110. In additional or alternative implementations, all or aspects of the NL based response system 120 can be implemented remotely from the client device 110 as depicted in FIG. 1 (e.g., at remote server(s)). In those implementations, the client device 110 and the NL based response system 120 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more applications, such as application 115, via which queries can be submitted and/or NL based summaries and/or other response(s) to the query can be rendered (e.g., audibly and/or visually). The application 115 can be an application that is separate from an operating system of the client device 110 (e.g., one installed “on top” of the operating system)—or can alternatively be implemented directly by the operating system of the client device 110. For example, the application 115 can be a web browser installed on top of the operating system, or can be an application that is integrated as part of the operating system functionality. The application 115 can interact with the NL based response system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110. Some instances of a query described herein can be a query that is formulated based on user input provided by a user of the client device 110 and detected via user input engine 111. For example, the query can be a typed query that is typed via a physical or virtual keyboard, a suggested query that is selected via a touch screen or a mouse, a spoken voice query that is detected via microphone(s) of the client device, or an image query that is based on an image captured by a vision component of the client device.

In various implementations, the client device 110 can include a rendering engine 112 that is configured to provide content (e.g., an NL based summary, creative generative model output, chat output, etc.) for audible and/or visual presentation to a user of the client device 110 using one or more user interface output devices. For example, the client device 110 can be equipped with one or more speakers that enable content to be provided for audible presentation to the user via the client device 110. Additionally, or alternatively, the client device 110 can be equipped with a display or projector that enables content to be provided for visual presentation to the user via the client device 110.

In various implementations, the client device 110 can include a context engine 113 that is configured to determine a context (e.g., current or recent context) of the client device 110 and/or of a user of the client device 110. In a multi-turn session between the user and an automated assistant (alternatively, “virtual assistant”, “chatbot”, etc.), the context of the client device and/or user may be maintained over multiple turns as a “user state.”

In some implementations, the context engine 113 can determine a context and/or update the user's state utilizing current or recent interaction(s) via the client device 110, a location of the client device 110, profile data of a profile of a user of the client device 110 (e.g., an active user when multiple profiles are associated with the client device 110), and/or other data accessible to the context engine 113. For example, the context engine 113 can determine a current context based on a one or more recent queries of the search session, profile data, and/or a current location of the client device 110. For instance, the context engine 113 can determine a current context of “looking for a healthy lunch restaurant in Louisville, Kentucky” based on a recently issued query, profile data, and a location of the client device 110.

As another example, the context engine 113 can determine a current context based on which application is active in the foreground of the client device 110, a current or recent state of the active application, and/or content currently or recently rendered by the active application. A context determined by the context engine 113 can be utilized, for example, in supplementing or rewriting a query that is formulated based on user input, in generating an implied query (e.g., a query formulated independent of user input), and/or in determining to submit an implied query and/or to render result(s) (e.g., an NL based summary) for an implied query. And the user's context across multiple turns of a search session can be used as the aforementioned user state to enrich output rendered, e.g., by a search chatbot companion, at each turn of the multi-turn human-to-computer dialog session.

In various implementations, the client device 110 can include an implied input engine 114 that is configured to: generate an implied query independent of any user input directed to formulating the implied query; to submit an implied query, optionally independent of any user input that requests submission of the implied query; and/or to cause rendering of result(s) for an implied query, optionally independent of any user input that requests rendering of the result(s)). For example, the implied input engine 114 can use current context, from current context engine 113, in generating an implied query, determining to submit the implied query, and/or in determining to cause rendering of result(s) for the implied query. For instance, the implied input engine 114 can automatically generate and automatically submit an implied query based on the current context. Further, the implied input engine 114 can automatically push result(s) to the implied query to cause them to be automatically rendered or can automatically push a notification of the result(s), such as a selectable notification that, when selected, causes rendering of the result(s). As another example, the implied input engine 114 can generate an implied query based on profile data (e.g., an implied query related to an interest of a user), submit the query at regular or non-regular intervals, and cause corresponding result(s) for the submission(s) to be automatically provided (or a notification thereof automatically provided). For instance, the implied query can be “patent news” based on profile data indicating interest in patents, the implied query periodically submitted, and a corresponding NL based summary result automatically rendered. It is noted that the provided NL based summary result can vary over time in view of e.g., presence of new/fresh search result document(s) over time.

Further, the client device 110, the NL based response system 120, and/or the search system 104 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form a coordinated ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

NL based response system 120 is illustrated as including a generative model (GM) selection engine 124, a GM input engine 126, a GM response generation engine 128, a fragment extraction engine 130, an entailment filtering engine 132, an entailment evaluation engine 134, a query formulation engine 137, and a user interface (UX) engine 136. Some of the engines can be omitted and/or combined in various implementations.

The GM selection engine 124 can, for example, select zero or more generative models from multiple candidate generative models. For example, in some iterations the system will determine to not utilize any of the candidate generative models, in some iterations the system will determine to utilize only one of the candidate generative models, and in some iterations the system will determine to utilize multiple of the candidate generative models. GM selection engine 124 can optionally utilize one or more rules and/or one or more classifiers 125 that are trained to generate output identifying which generative models are best suited to generate a response to a current query, given a current user state/context.

The GM input engine 126 may be configured to assemble generative model input prompts based on data such as a current query, current user state/context, past queries, past generative outputs (which may be included in the current user state/context, etc. Generative model input prompts may, in some implementations, include a sequence of tokens, which may be words, phrases, or embeddings generated from data such as text, images, audio, etc.

The GM response generation engine 128 may be configured to apply one or more generative models stored in in a GM database 129 to input prompts generated by GM input engine 126 to generate generative model output. Generative model output may take various forms, such as a sequence of tokens that correspond to, represent, or directly convey words, phrases, embeddings, images, videos, audio, etc. Generative models stored in GM database 129 may take a variety of forms, including, but not limited to, model(s) such as PaLM, BERT, LaMDA, Meena, and/or any other generative model, such as any other generative model that is encoder-only based, decoder-only based, sequence-to-sequence based and that optionally includes an attention mechanism or other memory, diffusion model(s), etc. Generative models may have hundreds of millions, or even hundreds of billions of parameters. In some implementations, generative models may include multi-modal models such as a vision language model (VLM) and/or a visual question answering (VQA) model, which can have any of the aforementioned architectures, and which can be used to process multiple modalities of data, particularly images and text, and/or images and audio for example, to generate one or more modalities of output. Non-limiting examples of VLMs that may be applied as described herein include Gemini and/or Flamingo, to name a few.

Fragment extraction engine 130 may be configured to extract meaningful fragments of text (e.g., statements, complete sentences, independent clauses that stand on their own) from generative model output generated by GM response generation engine 128. For instance, in the generative model response “George Washington was the first President of the United States. He was born on Feb. 22, 1732, on his family's plantation on Papes Creek in Westmoreland County, Virginia,” the following fragments could be extracted: (i) “George Washington was the first President of the United States”; (ii) “He was born on Feb. 22, 1732”; and (iii) “He was born on his family's plantation on Papes Creek in Westmoreland County, Virginia.”

Entailment filtering engine 132 may be configured to evaluate the textual fragments extracted from generative model output by fragment extraction engine 130 using various criteria and/or techniques to determine which are suitable for textual entailment analysis (or put another way, “require attribution”). For example, phrases such as “Good afternoon” and “Thank you” are not suitable for textual entailment analysis because they do not state facts that can be corroborated or contradicted/refuted. By contrast, the statement “George Washington was the first President of the United States” is suitable for textual entailment analysis because it states at least one verifiable fact: that George Washington was the first US President.

Entailment filtering engine 132 may evaluate textual fragments extracted from generative model output for suitability for textual entailment analysis in various ways. In some implementations, entailment filtering engine 132 may use data sources such as a knowledge graph to identify entities and/or facts related to entities in textual fragments. If an entity and/or fact is identified based on a fragment, that fragment may be suitable for textual entailment analysis. If no entities or facts are identified, as would be the case for a statement such as “Good morning” or “thank you,” that fragment may not be suitable for textual entailment analysis, and may be discarded (or “filtered”) from consideration.

Additionally or alternatively, in some implementations, entailment filtering engine 132 may use one or more classifiers 133 that are trained to generate output indicative of whether input textual fragments are suitable for textual entailment analysis. Such a classifier may be trained, for instance, on a corpus of training data that includes textual fragments labeled as suitable or not suitable for textual entailment analysis. Classifier(s) 133 may take various forms, including machine learning models such as recurrent neural networks (RNNs), long short-term memory (LSTM) networks, gated recurrent unit (GRU) networks, transformers (e.g., with self-attention), or various type of generative models mentioned previously, including “scaled down” generative models that have less parameters than generative models used, e.g., by GM response generation engine 128. For example, an LLM used by GM response engine 128, which may include billions of parameters, may be used as a “teacher” model to train a “student” model (e.g., another LLM) with considerably fewer parameters to perform entailment filtering.

Entailment evaluation engine 134 may be configured to evaluate textual fragments that were classified as suitable for textual entailment analysis by entailment filtering engine 132 based on documents retrieved using those fragments. For instance, entailment evaluation engine 134 or another component, such as query formulation engine 137, may formulate, for each textual fragment that remains after entailment filtering engine 132 has filtered out unsuitable textual fragments, a search query that seeks documents or other content that can be used to corroborate or refute the textual fragment. In some implementations, query formulation engine 137 may leverage one or more machine learning models, such as one or more generative models 129 or separate model(s) (e.g., LLMs, recurrent neural networks, etc.), to formulate these search queries. Entailment evaluation engine 134 may then process the textual fragments and responsive documents/content using one or more entailment models 135.

For example, in some implementations, entailment evaluation engine 134 may assemble input prompts for both a corroboration entailment model 135A and a contradiction entailment model 135B. Each input prompt may include content extracted or otherwise derived from one or more responsive documents returned by search system(s) 140 based on one or more search queries formulated by query formulation engine 137. Models 135A-B may generate two different outputs, one output that is indicative of whether the responsive content corroborates (or “entails”) the textual fragment, and another output that is indicative of whether the responsive content contradicts the textual fragment. In other implementations, entailment evaluation engine 134 may use a single entailment model that generates an output such as a corroboration score and/or a classification of “corroborates” or “contradicts.” Whichever the case, based on these output(s), entailment evaluation engine 134 may generate various predictions of whether the at least one document corroborates or contradicts the textual fragment.

UX engine 136 may be configured to cause data indicative of the predictions made by entailment evaluation engine 134 to be presented at client device 110. For instance, in some implementations, UX engine 136 may cause annotation(s) to be added to generative model output that is presented at client device 110, e.g., by providing data indicative of the annotations to rendering engine 112 so that rendering engine 112 can modify a GUI to annotate textual segments according to their entailment predictions. For instance, a sentence that is corroborated may be visually emphasized (e.g., highlighted) using one color, another sentence that is contradicted may be visually emphasized using another color, and so forth. In some implementations, these visual annotations may be operable to cause additional information to be presented. For example, clicking on a passage flagged as being contradicted may cause a pop-up window or similar visual element to be rendered at client device that conveys the document or other content that tends to contradict or call into question the veracity of the passage.

Search system 140 is illustrated as including an SRD engine 142 and a results engine 144. Some of the engines can be omitted or combined with each other in various implementations. The SRD engine 142 can, for example, utilize indices 143 and/or other resources in identifying search result documents that are responsive to queries as described herein. For example, SRD engine 142 can use queries formulated by component(s) of NL based response system 120, such as query formulation engine 137, to identify search result documents or other content that potentially corroborates and/or contradicts textual fragments. The results engine 144 can generate search results that can optionally be presented along with an NL based summary described herein, and/or that may be used by GM response generation engine 128 to generate generative model responses.

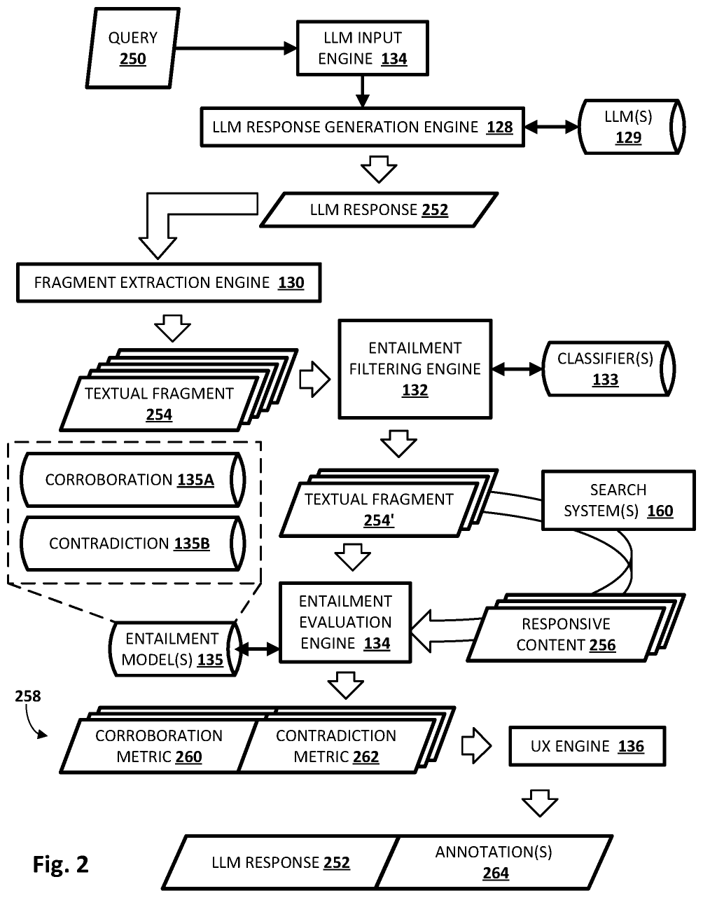

FIG. 2 schematically depicts an example of how various components depicted in FIG. 1 may cooperate to carry out selected aspects of the present disclosure. Starting at top right in the dashed rectangle, a NL based query 250 may be received, e.g., at user input engine 111 of client device 110. NL based query 250 may be typed, may be transcribed using ASR on a spoken utterance, or may even be an implied query. Whichever the case, data indicative of NL based query 250 may be processed by GM response generation engine 128 using one or more generative models from database 129 to generate a GM response 252.

While not shown in FIG. 2 for purposes of brevity and simplicity, it should be understood that in various implementations, other components upstream of GM response generation engine 128, such as one or more of engines 124-126, may perform various operations to prepare the input prompt that is ultimately processed by GM response generation engine 128 using generative model(s) such as LLM (s) to generate GM response 252. GM response 252 may include, for instance, one or more sentences, paragraphs, images, audio, video, etc., that are responsive to NL based query 250. It should also be understood that techniques described herein that are represented outside of the dashed box at top in FIG. 2 may be used to perform entailment analysis of content other than generative model response 252. For example, and as shown at top left in FIG. 2, any other type of document 251 (e.g., web page, social media post, video or transcript thereof, etc.) may be processed by fragment extraction engine 130 and the other components depicted downstream in FIG. 2 to perform entailment analysis on that document 251.

GM response 252 (or document 251 as the case may be) may be processed by fragment extraction engine 130 to extract some number of content fragments 254 (e.g., sentences, clauses, expressions, phrases, claims, images or portions thereof, audio or portions thereof, videos or portions thereof, etc.) that can be independently processed by downstream components. In various implementations, fragment extraction engine 130 may employ rules-based or machine learning-based approaches to extract fragments 254. In the former case, fragment extraction engine 130 may extract individual sentences, clauses of sentences separated by punctuation, etc. Alternatively, fragment extraction engine 130 may use a machine learning model, such as a deep neural network, to extract fragments 254. For example, the machine learning model may be trained to process data indicative of GM response 252 (or document 251) and output data indicative of predicted barriers between textual fragments of the GM response 252 (or document 251).

However fragments 254 are extracted, entailment filtering engine 132 may be configured to classify a subset 254′ of the fragments 254 as being suitable for textual entailment analysis. For example, entailment filtering engine 132 may employ one or more trained classifiers 133 to classify individual fragments of content as being suitable or not suitable for textual entailment analysis, or in case of regression, to predict suitability scores for textual entailment analysis. As noted previously, classifier(s) 133 may take various forms, such as transformer-based generative models (e.g., LLMs), RNNs, LSTM networks, GRU networks, or other types of encoder-decoder, encoder only, or decoder only models. In other implementations, entailment filtering engine 132 may use rules based approaches to filter out content fragments that are not suitable for textual entailment analysis. For example, entailment filtering engine 132 may leverage a knowledge graph or other database to identify entities and/or facts in content fragments, which in turn may suggest suitability for textual entailment analysis.

The subset 254′ of textual fragments deemed suitable for textual entailment analysis may be provided to both search system(s) 140 and entailment evaluation engine 134. Search system(s) 140 may use the subset of textual fragments to formulate some number of search queries (not depicted in FIG. 2). These search queries may be used by engine 142 and/or 144 of search system(s) 140 to retrieve responsive content 256. Responsive content 256 may include documents (e.g., text-based, images, audio, etc.), snippets/portions of documents that are most directly responsive to a search query, or other content that is derived from responsive documents (e.g., using LLMs, VLMs, etc.). Responsive content 256 can be paired as applicable with the textual fragments of the subset 254′.

In some implementations, SRD engine 142 and/or results engine 144 may be configured to evaluate the quality, credibility, and/or reliability of search result document(s) (or more generally, responsive content 256), and provide one or more responsive content quality metrics to other components described herein, such as components of NL based response system 120. These responsive content quality metrics may be determined in various ways. In some implementations, the responsive content quality metrics may include query-dependent metrics, which are metrics that account for both the search query and the responsive content together. Additionally or alternatively, in some implementations, these responsive content quality metrics may include query-independent metrics, which may include metrics that are determined, e.g., by search system 140, independently of any queries.

In various implementations, these responsive content quality metric(s) may be used, e.g., by entailment filtering engine 132 and/or entailment evaluation engine 134, as a threshold for determining whether to proceed with textual entailment analysis. For example, while a particular textual fragment may be deemed suitable for textual entailment analysis by entailment filtering engine 132, entailment evaluation engine 134 may determine that responsive content 256 that is retrieved based on the particular textual fragment is not of sufficient quality to be considered as corroborating or contradicting the textual fragment. For example, the website from which responsive content 256 was obtained may be deemed to lack credibility. In some such instances, entailment evaluation engine 134 and/or UX engine 136 may refrain from visually annotating the textual fragment in the GM response 252 (or document 251). In other such instances, entailment evaluation engine 134 and/or UX engine 136 may cause client device 110 to render output that indicates potentially weakly corroborating or contradicting evidence.

Entailment evaluation engine 134 may process pairs of textual fragments 254′ and corresponding responsive content 256 (whole documents or fragments/snippets extracted therefrom) using one or more entailment models 135 to generate predictions 258 of whether responsive content 256 corroborate or contradict corresponding textual fragments. In FIG. 2, for instance, entailment evaluation engine 134 processes the pairs of textual fragments 254′ and corresponding responsive content 256 using a corroboration model 135A and a contradiction model 135B. Consequently, predictions 258 include both corroboration metrics 260 and contradiction metrics 262.

In some implementations, models 135A, 135A may be applied to copies of the pairs in parallel (e.g., as separate threads) to speed up processing and/or reduce latency. Additionally or alternatively, in some implementations, entailment evaluation engine 134 may process multiple different pairs of textual fragments 254′ and corresponding responsive content 256 in parallel to further reduce latency.

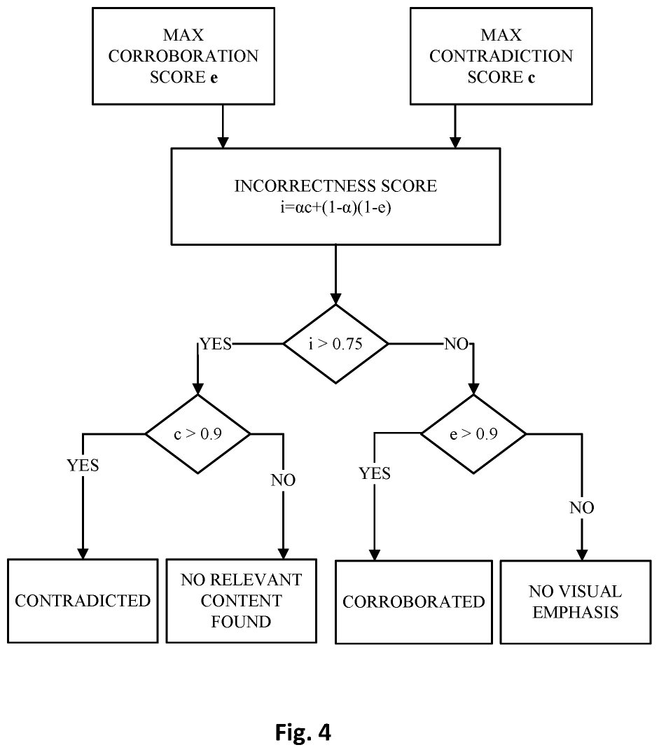

In various implementations, corroboration metrics 260 and contradiction metrics 262 may be evaluated, e.g., by entailment evaluation engine 134 and/or another component, such as UX engine 136, to determine how to cause visual or audio output to be rendered at client device 110. In FIG. 2, for instance, UX engine 136 uses corroboration metrics 260 and contradiction metrics 262 to generate visual and/or audio annotations 264 that can be applied to GM response 252 and/or document 251, e.g., when GM response 252/document 251 is initially rendered by rendering engine 112 of client device 110 or after GM response 252/document has been rendered without annotations. One non-limiting example of such rules and/or heuristics that may be used by UX engine 136 or another component is demonstrated in FIG. 4. In some implementations, UX engine 136 may select various attributes of the annotations based on a comparison (e.g., an example depicted in FIG. 4) of the corroboration metric 260 with the contradiction metric 262. For instance, visual attributes such as text color, highlighting color, etc., may be selected based on this comparison. For instance, if a text fragment is determined to be contradicted by corresponding responsive content, then a color such as orange or red may be selected. If the text fragment is determined to be corroborated by corresponding responsive content, then a color such as gray or blue, or even no color, may be selected. In various implementations, UX engine 136 may render corroborated and/or contradicted content as selectable elements that when selected, surface the responsive content 256 that was the basis of the corroboration and/or contradiction.

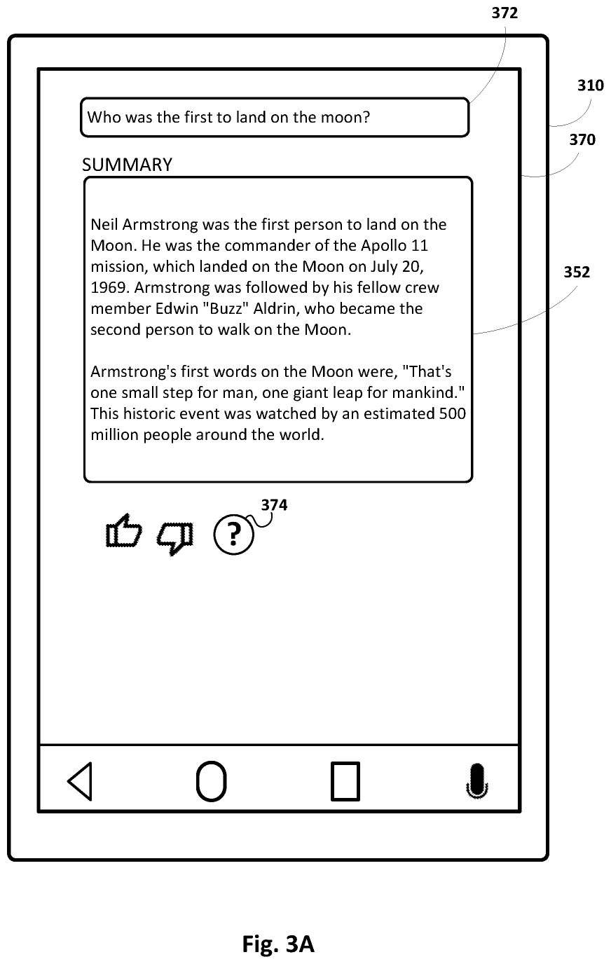

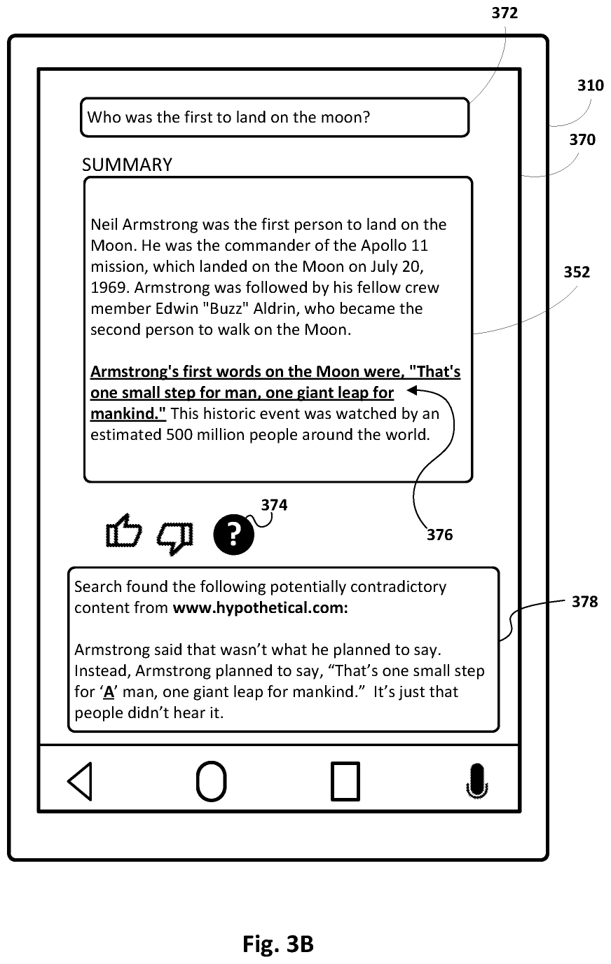

FIG. 3A depicts an example client device 310 in the form of a tablet computer that is being used to engage with NL based response system 120. Client device 310 includes a display 370 on which a query input field 372 is rendered. A user (not depicted) has entered, into query input field 372 (by typing or having a spoken utterance speech recognized), the query, “Who was the first to land on the moon?” A GM response 352 that may share various characteristics with GM response 252 in FIG. 2 is generated by GM response generation engine 128 and rendered on display 370. Also rendered on display 370 are a thumbs up and down that are operable by the user to provide positive or negative feedback, respectively, about GM response 352, as well as an operable graphical element 374 that the user can select to initiate selected aspects of the present disclosure. In particular, the user may operate element 374 in order to initiate the process depicted in FIG. 2 to perform textual entailment analysis and provide visual annotations about constituent textual fragments of GM response 352.

In FIG. 3B, element 374 has been selected. As a consequence, the process of FIG. 2 is performed, and a textual fragment 376 of GM response 352 has been annotated. Textual fragment 376 reads, “Armstrong's first words on the Moon were, ‘That's one small step for man, one giant leap for mankind.’” Textual fragment 376 has been visually annotated because the processing of FIG. 2 revealed that there is a source of data that tends to contradict this statement. Textual fragments may be visually annotated in various ways based on, for instance, various combinations of corroboration metrics 260 and/or contradiction metrics 262. In some implementations, a first color such as green may be used to visually annotate textual fragments that are corroborated, e.g., via highlighting, font color, etc. A second color such as red or orange may be used to visually annotate textual fragments that are contradicted. In some implementations, a continuous or discrete range of colors may be used to visually annotate textual fragments in accordance with where those textual fragments fall on a continuous or discrete spectrum between corroborated and contradicted. Other visual annotations may be used in addition to or instead of font color, such as font type (e.g., Calibri, Times New Roman, Helvetica, etc.), font size, bold, underline, italics, underscore, etc.

In various implementations, the user may select textual fragment 376 to cause a pop-up window 378 or other similar auxiliary interface (e.g., a new browser tab that opens, and in some instances scrolls to, the contradicting content) to be rendered at client device 310. The window 378 may depict information about content such as a search result document or snippet(s)/fragment(s) from the document that tend to contradict textual fragment 376. In FIG. 3B, for instance, window 378 displays a snippet extracted from www.hypothetical.com that tends to contradict textual fragment 376: “Armstrong said that wasn't what he planned to say. Instead, Armstrong planned to say, ‘That's one small step for ‘A’ man, one giant leap for mankind.’ It's just that people didn't hear it.” While a contradictory example is shown in FIG. 3B, it should be understood that similar annotations (e.g., in different colors) and auxiliary interfaces may be rendered and/or made available for textual fragments that are corroborated.

FIG. 4 schematically depicts an example of logic that may be implemented, e.g., by UX engine 136, to determine how to visually annotate a textual fragment based on corroboration metrics 260 and contradiction metrics 262. Starting at top, for a given textual fragment (254′ in FIG. 2) and corresponding responsive content (256 in FIG. 2), a maximum corroboration score e may be generated, e.g., by entailment evaluation engine 134 using corroboration model 135A. Likewise, a maximum contradiction score c may be generated, e.g., by entailment evaluation engine 134 using contradiction model 135B.

A general “incorrectness” score i may then be calculated. In some implementations, the incorrectness score is a weighted average between the maximum contradiction score c and the maximum corroboration score e (or in some cases, 1-e). Taking a weighted average may account for the situation in which no documents or other responsive content is found that strongly contradicts or corroborates the fragments. In some implementations, the following formula may be usd, with α being a weight determined from empirical evidence:

$$i = α c + ( 1 - α ) ( 1 - e ) \qquad ( 1 )$$

If i is greater than a first threshold, say, 0.75, then c may be compared to a second threshold, say, 0.9. If c is greater than the second threshold, then the given textual fragment may be considered contradicted by the responsive content. As a result, UX engine 136 may, for instance, highlight or otherwise visually emphasize the given textual fragment in a color such as red or orange. However, if c is less than the second threshold, then a determination of “no relevant content found” or similar inclusive output may be generated. In such a case, the given textual fragment may not be annotated at all, or may be visually emphasized with a neutral color such as gray.

Going back to equation (1), if i is less than the first threshold (e.g., 0.75), then e may be compared to a third threshold, say, 0.9 (which may or may not be the same as the second threshold). If e is greater than the third threshold, then the given textual fragment may be considered corroborated. Consequently, the given textual fragment may be annotated at client device (110, 310) in another color such as green or blue. However, if e is less than the third threshold, then the given textual fragment may not be visually emphasized. The thresholds depicted in FIG. 4 are for demonstration purposes only, and are not meant to be limiting.

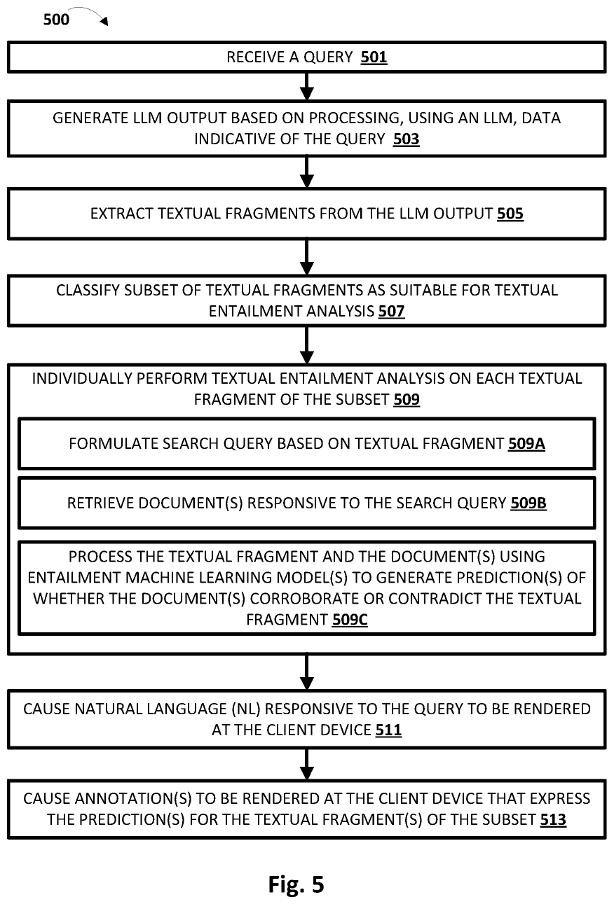

Turning now to FIG. 5, a flowchart is depicted that illustrates an example method 500 of implementing selected aspects of the present disclosure. For convenience, the operations of the method 500 are described with reference to a system that performs the operations. This system of the method 500 includes one or more processors, memory, and/or other component(s) of computing device(s) (e.g., client device 110 of FIG. 1, one or more servers, and/or other computing devices). Moreover, while operations of the method 500 are shown in a particular order, this is not meant to be limiting. One or more operations may be reordered, omitted, and/or added.

At block 501, the system, e.g., by way of user input engine 111 of client device 110, may receive a query associated with a client device operated by the user. For example, user input engine 111 may capture and transcribe a spoken utterance into a textual query, and then provide that textual query to NL based response system 120. Alternatively, the user may type a textual query.

At block 503, the system, e.g., by way of GM response generation engine 128, may generate generative model output (e.g., 252, 352) based on processing data indicative of the query using a generative model from database 129. Data indicative of the query may include, for instance, a sequence of tokens that includes words, phrases, and/or characters of the query, or embeddings generated therefrom.

At block 505, the system, e.g., by way of fragment extraction engine 130, may extract a plurality of fragments (textual or otherwise) from the generative model output. At block 507, the system, e.g., by way of entailment filtering engine 132, may classify a subset (e.g., 254′) of the fragments as being suitable for textual entailment analysis, e.g., using one or more classifier models from database 133.

At block 509, the system, e.g., by way of entailment evaluation engine 134, may individually perform textual entailment analysis on each textual fragment of the subset. In various implementations, the textual entailment analysis may include, for each textual fragment of the subset, performing operations associated with blocks 509A-C. At block 509A, for instance, the system may formulate a search query based on the textual fragment of the subset currently under consideration. For instance, words and/or phrases of the fragment of the subset may be used to formulate a search query.

At block 509B, the system may retrieve at least one document or portion thereof (or more generally, content) that is responsive to the search query. At block 509C, the system may process the textual fragment under consideration and the at least one document retrieved at block 509B using one or more entailment machine learning models 135 to generate one or more predictions of whether the at least one document corroborates or contradicts the textual fragment. For example, as illustrated in FIG. 2, the textual fragment and responsive content may be processed using both a corroboration model 135A and a contradiction model 135B, e.g., in parallel, to generate corroboration metric 260 and contradiction metric 262, respectively.

At block 511, the system, e.g., by way of UX engine 136, may cause natural language (NL) responsive to the query to be rendered at the client device. In some implementations, the NL responsive to the query may be rendered initially without annotations, and then may be updated with annotations sometime later, e.g., after a predetermined time interval, after techniques described herein have had time to complete, in response to use actuation of a user interface element such as 375, etc.

At block 513, the system, e.g., by way of UX engine 136, may cause one or more annotations to be rendered at the client device 110. In various implementations, the one or more annotations may express, convey, or otherwise represent (visually or audibly) one or more of the predictions for one or more of the textual fragments of the subset.

While examples described herein have related primarily to performing entailment analysis on generative model output, this is not meant to be limiting. In various implementations, techniques described herein may be used to perform entailment analysis on any type of document. For example, web pages can be created by anyone without any oversight, and as a consequence, inaccurate information is propagated across the Internet. Techniques described herein may be used to perform entailment analysis on web pages and/or on any other type of document, such as textual documents, videos (e.g., with transcripts that can be evaluated), and so forth. In some such cases, the operations of method 500 may be performed beginning at block 505, with the document under consideration replacing the generative model output.

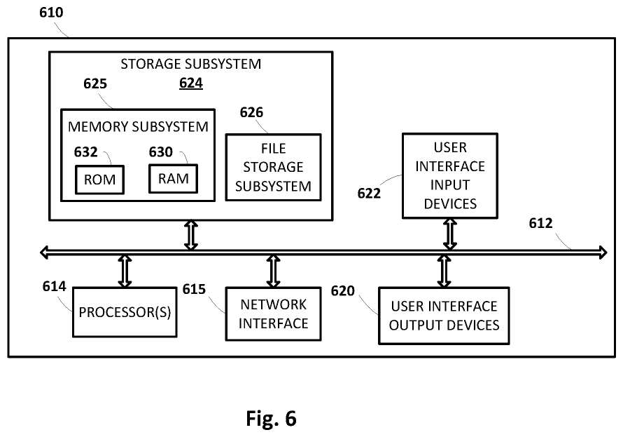

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1 or 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614. Bus subsystem 612 provides a mechanism for letting the various components and subsystems of computing device 610 communicate with each other as intended. Although bus subsystem 612 is shown schematically as a single bus, alternative implementations of the bus subsystem 612 may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be altered before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that the user's particular geographic location cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented by one or more processors, comprising:
receiving a query associated with a client device operated by the user;
generating generative model output based on processing, using a generative model, data indicative of the query;
extracting a plurality of textual fragments from the generative model output;
classifying a subset of the textual fragments as being suitable for textual entailment analysis;
individually performing textual entailment analysis on each textual fragment of the subset, wherein the textual entailment analysis includes, for each textual fragment of the subset:
formulating a search query based on the textual fragment,
retrieving at least one document that is responsive to the search query, and
processing the textual fragment and the at least one document using one or more entailment machine learning models to generate one or more predictions of whether the at least one document corroborates or contradicts the textual fragment;
causing natural language (NL) responsive to the query to be rendered at the client device; and
causing one or more annotations to be rendered at the client device, wherein the one or more annotations express one or more of the predictions for one or more of the textual fragments of the subset.

2. The method of claim 1, wherein the one or more entailment machine learning models comprise:
a corroboration machine learning model trained to generate first output indicative of whether a document corroborates a textual fragment; and
a contradiction machine learning model trained to generate second output indicative of whether a document contradicts a textual fragment.

3. The method of claim 2, wherein one or more of the predictions is determined based on a comparison of the first and second outputs.

4. The method of claim 3, wherein one or more of the annotations is rendered using one or more visual attributes that are selected based on the comparison.

5. The method of claim 1, wherein each textual fragment of the subset is classified as suitable for textual entailment analysis using a classifier machine learning model that is trained to classify textual fragments as capable or incapable of textual entailment analysis.

6. The method of claim 1, wherein each textual fragment of the subset is classified as suitable for textual entailment analysis based on an entailment score predicted for the textual fragment using a regression machine learning model that is trained to predict textual entailment analysis suitability scores for textual fragments.

7. The method of claim 1, wherein the subset includes a plurality of textual fragments, and the textual entailment analysis is performed for the plurality of textual fragments in parallel.

8. The method of claim 1, wherein the one or more annotations expressing one or more of the predictions comprise:
a first annotation that visually highlights one of the textual fragments that is corroborated by one of the documents in a first color; and
a second annotation that visually highlights another of the textual fragments that is contradicted by one of the documents in a second color that is different than the first color.

9. The method of claim 1, wherein a given annotation of the annotations expressing one or more of the predictions is operable to retrieve at least a portion of the document that corroborates or contradicts the textual fragment underlying the given annotation.

10. The method of claim 9, further comprising causing a pop-up window to be rendered at the client device, wherein the pop-up window conveys the portion of the document that corroborates or contradicts the textual fragment underlying the given annotation.

11. The method of claim 9, further comprising causing a new web browser tab to be rendered at the client device, wherein the new web browser tab conveys all or a portion of the document that corroborates or contradicts the textual fragment underlying the given annotation.

12. The method of claim 11, wherein the new web browser tab is automatically scrolled to a location of the document that contains the portion that corroborates or contradicts the textual fragment underlying the given annotation.

13. The method of claim 1, further comprising causing one or more interactive feedback elements to be rendered at the client device, wherein the one or more interactive feedback elements are operable to accept or reject one or more of the predictions for one or more of the textual fragments of the subset.

14. The method of claim 1, wherein the NL responsive to the query is rendered at the client device without annotations prior to the one or more annotations being rendered.

15. The method of claim 1, wherein the one or more predictions of whether the at least one document corroborates or contradicts the textual fragment are generated conditionally based on a responsive content quality metric determined for the at least one document.

16. A system comprising one or more processors and memory storing instructions that, in response to execution by the one or more processors, cause the one or more processors to:
receive a query associated with a client device operated by the user;
generate generative model output based on processing, using a generative model, data indicative of the query;
extract a plurality of textual fragments from the generative model output;
classify a subset of the textual fragments as being suitable for textual entailment analysis;
individually perform textual entailment analysis on each textual fragment of the subset, wherein the textual entailment analysis includes, for each textual fragment of the subset:
formulating a search query based on the textual fragment,
retrieving at least one document that is responsive to the search query, and
processing the textual fragment and the at least one document using one or more entailment machine learning models to generate one or more predictions of whether the at least one document corroborates or contradicts the textual fragment;
cause natural language (NL) responsive to the query to be rendered at the client device; and
cause one or more annotations to be rendered at the client device, wherein the one or more annotations express one or more of the predictions for one or more of the textual fragments of the subset.

17. The system of claim 16, wherein the one or more entailment machine learning models comprise:
a corroboration machine learning model trained to generate first output indicative of whether a document corroborates a textual fragment; and
a contradiction machine learning model trained to generate second output indicative of whether a document contradicts a textual fragment.

18. The system of claim 17, wherein one or more of the predictions is determined based on a comparison of the first and second outputs.

19. At least one non-transitory computer-readable medium comprising instructions that, when executed by one or more processors, cause the one or more processors to:
receive a query associated with a client device operated by the user;
generate generative model output based on processing, using a generative model, data indicative of the query;
extract a plurality of textual fragments from the generative model output;
classify a subset of the textual fragments as being suitable for textual entailment analysis;
individually perform textual entailment analysis on each textual fragment of the subset, wherein the textual entailment analysis includes, for each textual fragment of the subset:
formulating a search query based on the textual fragment,
retrieving at least one document that is responsive to the search query, and
processing the textual fragment and the at least one document using one or more entailment machine learning models to generate one or more predictions of whether the at least one document corroborates or contradicts the textual fragment;
cause natural language (NL) responsive to the query to be rendered at the client device; and
cause one or more annotations to be rendered at the client device, wherein the one or more annotations express one or more of the predictions for one or more of the textual fragments of the subset.

20. The non-transitory computer-readable medium of claim 19, wherein the one or more entailment machine learning models comprise:
a corroboration machine learning model trained to generate first output indicative of whether a document corroborates a textual fragment; and
a contradiction machine learning model trained to generate second output indicative of whether a document contradicts a textual fragment.
